(19) United States
(12) Patent Application Publication
(10) Pub. No.: US 2021/0020055 A1
(43) Pub. Date: Jan. 21, 2021

(54) DRONE DETECTION SYSTEMS AND RELATED PRESENTATION METHODS

(71) Applicant: HONEYWELL INTERNATIONAL INC., Morris Plains, NJ (US)

(72) Inventors: Suresh Bazawada, Bangalore (IN); Anil Kumar Songa, Bangalore (IN); Vasudev Prakash Shanbhag, Bangalore (IN); Anish Kumar Michaelas, Bangalore (IN); Sai Phanidhar, Bangalore (IN); Kanagaraj Karuppusamy, Bangalore (IN); Siddaray Medegar, Bangalore (IN); Harish M, Bangalore (IN)

(73) Assignee: HONEYWELL INTERNATIONAL INC., Morris Plains, NJ (US)

(21) Appl. No.: 16/513,442

(22) Filed: Jul. 16, 2019

(51) Int. Cl. G08G 5/00; B64D 43/00

(52) U.S. Cl. CPC G08G 5/0082; B64D 43/00; G08G 5/0069; G08G 5/0026

(57) ABSTRACT

Methods and systems are provided for presenting unmanned vehicles, such as drones, operating in the vicinity of a planned route of travel. One exemplary method involves displaying a graphical representation of a route for a vehicle on a display device onboard the vehicle, determining a range of an unmanned vehicle based on one or more signals associated with the unmanned vehicle, and displaying a graphical representation of the range of the unmanned vehicle on the display device when at least some of the range is within a threshold distance of the route.

### TECHNICAL FIELD

The subject matter described herein relates generally to vehicle systems, and more particularly, embodiments of the subject matter relate to aircraft systems capable of detecting and depicting unmanned aerial vehicles operating in the vicinity of a planned flight path.

### BACKGROUND

The proliferation of commercial- and consumer-grade unmanned aerial vehicles or “drones” is increasing congestion in the airspace. While regulatory authorities have worked to safely integrate hobbyists and other civilian users into the airspace, there remain any number of vehicles in use that are not properly registered or otherwise fail to consistently adhere to regulatory guidance or requirements. Often, this increases the risks of a pilot of another aircraft (e.g., a commercial aircraft, a military aircraft, or the like) being unaware of the potential danger that could be caused by a nearby vehicle. Accordingly, it desirable to improve pilot situational awareness and mitigate the potential threat of drones or other unmanned aerial vehicles operating near aircraft. Other desirable features and characteristics will become apparent from the subsequent detailed description and the appended claims, taken in conjunction with the accompanying drawings and the foregoing technical field and background.

### BRIEF SUMMARY

Methods and systems are provided for presenting unmanned vehicles operating in a vicinity of a planned route of travel for a vehicle. One exemplary method involves displaying a graphical representation of a route for a vehicle on a display device onboard the vehicle, determining a range of an unmanned vehicle based on one or more signals associated with the unmanned vehicle, and when at least some of the range is within a threshold distance of the route, displaying a graphical representation of the range of the unmanned vehicle on the display device.

In another embodiment, a method of presenting a drone on a display device onboard an aircraft involves displaying, on a display device onboard the aircraft, a graphical representation of a route defined by a flight plan for the aircraft, detecting, by a detection system onboard the aircraft, one or more radio frequency communications signals between a remote controller and the drone, determining a potential operating region for the drone based on the one or more signals, and in response to determining the potential operating region is within a display threshold distance of the route, displaying a graphical representation of the potential operating region for the drone on the display device.

In yet another embodiment, an aircraft system is provided. The aircraft system includes a display device to display a graphical representation of a flight plan, a detection system to detect one or more radio frequency communications signals associated with an unmanned aerial vehicle, and a processing system coupled to the display device and the detection system to determine an operating range associated with the unmanned aerial vehicle based on the one or more radio frequency communications signals and display a graphical representation of the operating range on the display device when at least a portion of the operating range is within a threshold distance of the route.

### BRIEF DESCRIPTION OF THE DRAWINGS

Embodiments of the subject matter will hereinafter be described in conjunction with the following drawing figures, wherein like numerals denote like elements, and:

FIG. 1 is a block diagram of a system for an aircraft in an exemplary embodiment;

FIG. 2 depicts communications signals between a remote controller and an unmanned aerial vehicle suitable for detection by a detection system onboard the aircraft in the system of FIG. 1 in accordance with one or more embodiments;

FIG. 3 is a flow diagram of an exemplary drone display process suitable for use with the aircraft in the system of FIG. 1 in accordance with one or more embodiments; and

FIGS. 4-7 depict exemplary graphical user interface (GUI) displays suitable for presentation on a display device onboard the aircraft in the system of FIG. 1 depicting graphical representations of the potential operating regions for a detected unmanned aerial vehicle in connection with one or more embodiments of the drone display process of FIG. 3.

### DETAILED DESCRIPTION

Embodiments of the subject matter described herein generally relate to systems and methods for graphically depicting the spatial relationship between a route of travel for a vehicle and one or more unmanned vehicles in a vicinity of the route. While the subject matter described herein could be utilized in various applications or in the context of various types of vehicles (e.g., automobiles, marine vessels, trains, or the like), exemplary embodiments are described herein in the context of depicting the operating the range of unmanned vehicles with respect to a flight plan for an aircraft. In this regard, exemplary embodiments may be described herein primarily in the context of remotely-controlled unmanned aerial vehicles (or “drones”); however, it should be appreciated the subject matter described herein is not limited to any particular type or combination of vehicles. As described in greater detail below, in exemplary embodiments, when the range of an unmanned vehicle is within a threshold distance of the flight plan, a graphical representation of the range of the unmanned vehicle is displayed or otherwise depicted with respect to a graphical representation of the route according to the flight plan, thereby providing situational awareness of the spatial relationship between the planned route for the aircraft and the potential operating region for the unmanned vehicle. In this regard, in one or more embodiments, unmanned vehicles are hidden or otherwise not presented on the display when their operating range is not within a threshold distance of the route to avoid cluttering the display.

In exemplary embodiments, the two-dimensional lateral range of the unmanned vehicle is depicted on a navigational map concurrently with a graphical representation of the flight plan route, thereby allowing the pilot, co-pilot, or other aircraft operator or user to analyze the lateral distance between the unmanned vehicle and the flight plan. Additionally, the lateral and vertical range of the unmanned vehicle may be depicted on a vertical profile display (or vertical situation display) concurrently with a graphical representation of the vertical profile of the flight plan route, thereby allowing the pilot to analyze the vertical separation distance between the unmanned vehicle and the flight plan. In this regard, in exemplary embodiments, the navigational map and the corresponding vertical profile display are concurrently presented on a common display device, thereby allowing a pilot or other user to correlate the lateral and vertical ranges of the unmanned vehicle with respect to the flight plan route, and thereby mentally gauge the three-dimensional operating range of the unmanned vehicle. Additionally, in one or more exemplary embodiments, the position of the remote control operator associated with the unmanned vehicle is determined and depicted concurrently with respect to the depicted operating range. In this regard, the position of the remote control operator may be continually and dynamically determined, such that graphical indication of the current or anticipated movement of the vehicle operating range may also be provided on the display, thereby providing situational awareness of how the potential risks posed by the unmanned vehicle may increase or decrease during operation.

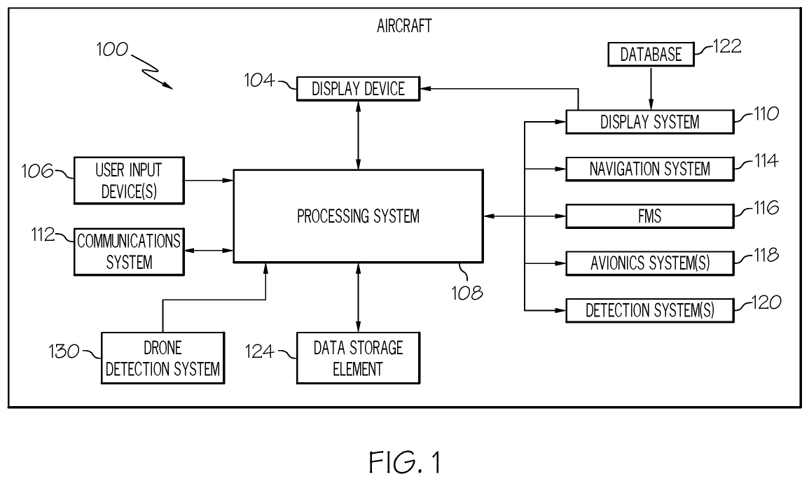

Referring now to FIG. 1, an exemplary embodiment of a system 100 which may be located onboard a vehicle, such as an aircraft 102, includes, without limitation, a display device 104, a user input device 106, a processing system 108, a display system 110, a communications system 112, a navigation system 114, a flight management system (FMS) 116, one or more avionics systems 118, one or more detection systems 120, 130, and one or more data storage elements 122, 124 cooperatively configured to support operation of the system 100, as described in greater detail below.

In exemplary embodiments, the display device 104 is realized as an electronic display capable of graphically displaying flight information or other data associated with operation of the aircraft 102 under control of the display system 110 and/or processing system 108. In this regard, the display device 104 is coupled to the display system 110 and the processing system 108, wherein the processing system 108 and the display system 110 are cooperatively configured to display, render, or otherwise convey one or more graphical representations or images associated with operation of the aircraft 102 on the display device 104. For example, as described in greater detail below, a navigational map that includes a graphical representation of the aircraft 102 and one or more of the terrain, meteorological conditions, airspace, air traffic, navigational reference points, and a route associated with a flight plan of the aircraft 102 may be displayed, rendered, or otherwise presented on the display device 104.

The user input device 106 is coupled to the processing system 108, and the user input device 106 and the processing system 108 are cooperatively configured to allow a user (e.g., a pilot, co-pilot, or crew member) to interact with the display device 104 and/or other elements of the aircraft system 100, as described in greater detail below. Depending on the embodiment, the user input device 106 may be realized as a keypad, touchpad, keyboard, mouse, touch panel (or touchscreen), joystick, knob, line select key or another suitable device adapted to receive input from a user. In some embodiments, the user input device 106 is realized as an audio input device, such as a microphone, audio transducer, audio sensor, or the like, that is adapted to allow a user to provide audio input to the aircraft system 100 in a “hands free” manner without requiring the user to move his or her hands, eyes and/or head to interact with the aircraft system 100.

The processing system 108 generally represents the hardware, circuitry, processing logic, and/or other components configured to facilitate communications and/or interaction between the elements of the aircraft system 100 and perform additional processes, tasks and/or functions to support operation of the aircraft system 100, as described in greater detail below. Depending on the embodiment, the processing system 108 may be implemented or realized with a general purpose processor, a controller, a microprocessor, a microcontroller, a content addressable memory, a digital signal processor, an application specific integrated circuit, a field programmable gate array, any suitable programmable logic device, discrete gate or transistor logic, processing core, discrete hardware components, or any combination thereof, designed to perform the functions described herein. In practice, the processing system 108 includes processing logic that may be configured to carry out the functions, techniques, and processing tasks associated with the operation of the aircraft system 100 described in greater detail below. Furthermore, the steps of a method or algorithm described in connection with the embodiments disclosed herein may be embodied directly in hardware, in firmware, in a software module executed by the processing system 108, or in any practical combination thereof. In accordance with one or more embodiments, the processing system 108 includes or otherwise accesses a data storage element 124, such as a memory (e.g., RAM memory, ROM memory, flash memory, registers, a hard disk, or the like) or another suitable non-transitory short or long term storage media capable of storing computer-executable programming instructions or other data for execution that, when read and executed by the processing system 108, cause the processing system 108 to execute and perform one or more of the processes, tasks, operations, and/or functions described herein.

The display system 110 generally represents the hardware, firmware, processing logic and/or other components configured to control the display and/or rendering of one or more displays pertaining to operation of the aircraft 102 and/or systems 112, 114, 116, 118, 120 on the display device 104 (e.g., synthetic vision displays, navigational maps, and the like). In this regard, the display system 110 may access or include one or more databases 122 suitably configured to support operations of the display system 110, such as, for example, a terrain database, an obstacle database, a navigational database, a geopolitical database, a terminal airspace database, a special use airspace database, or other information for rendering and/or displaying navigational maps and/or other content on the display device 104. In this regard, in addition to including a graphical representation of terrain, a navigational map displayed on the display device 104 may include graphical representations of navigational reference points (e.g., waypoints, navigational aids, distance measuring equipment (DMEs), very high frequency omnidirectional radio ranges (VORs), and the like), designated special use airspaces, obstacles, and the like overlying the terrain on the map.

Still referring to FIG. 1, in an exemplary embodiment, the processing system 108 is coupled to the navigation system 114, which is configured to provide real-time navigational data and/or information regarding operation of the aircraft 102. The navigation system 114 may be realized as a global positioning system (GPS), inertial reference system (IRS), or a radio-based navigation system (e.g., VHF omni-directional radio range (VOR) or long-range aid to navigation (LORAN)), and may include one or more navigational radios or other sensors suitably configured to support operation of the navigation system 114, as will be appreciated in the art. The navigation system 114 is capable of obtaining and/or determining the instantaneous position of the aircraft 102, that is, the current (or instantaneous) location of the aircraft 102 (e.g., the current latitude and longitude) and the current (or instantaneous) altitude (or above ground level) for the aircraft 102. The navigation system 114 is also capable of obtaining or otherwise determining the heading of the aircraft 102 (i.e., the direction the aircraft is traveling in relative to some reference).

In an exemplary embodiment, the processing system 108 is also coupled to the FMS 116, which is coupled to the navigation system 114, the communications system 112, and one or more additional avionics systems 118 to support navigation, flight planning, and other aircraft control functions in a conventional manner, as well as to provide real-time data and/or information regarding the operational status of the aircraft 102 to the processing system 108. It should be noted that although FIG. 1 depicts a single avionics system 118, in practice, the aircraft system 100 and/or aircraft 102 will likely include numerous avionics systems for obtaining and/or providing real-time flight-related information that may be displayed on the display device 104 or otherwise provided to a user (e.g., a pilot, a co-pilot, or crew member). For example, practical embodiments of the aircraft system 100 and/or aircraft 102 will likely include one or more of the following avionics systems suitably configured to support operation of the aircraft 102: a weather system, an air traffic management system, a radar system, a traffic avoidance system, an autopilot system, an autothrust system, a flight control system, hydraulics systems, pneumatics systems, environmental systems, electrical systems, engine systems, trim systems, lighting systems, crew alerting systems, electronic checklist systems, an electronic flight bag and/or another suitable avionics system.

In the illustrated embodiment, the onboard detection system(s) 120 generally represents the component(s) of the aircraft 102 that are coupled to the processing system 108 and/or the display system 110 to generate or otherwise provide information indicative of various objects or regions of interest within the vicinity of the aircraft 102 that are sensed, detected, or otherwise identified by a respective onboard detection system 120. For example, an onboard detection system 120 may be realized as a weather radar system or other weather sensing system that measures, senses, or otherwise detects meteorological conditions in the vicinity of the aircraft 102 and provides corresponding radar data (e.g., radar imaging data, range setting data, angle setting data, and/or the like) to one or more of the other onboard systems 108, 110, 114, 116, 118 for further processing and/or handling. For example, the processing system 108 and/or the display system 110 may generate or otherwise provide graphical representations of the meteorological conditions identified by the onboard detection system 120 on the display device 104 (e.g., on or overlying a lateral navigational map display). In another embodiment, an onboard detection system 120 may be realized as a collision avoidance system that measures, senses, or otherwise detects air traffic, obstacles, terrain and/or the like in the vicinity of the aircraft 102 and provides corresponding detection data to one or more of the other onboard systems 108, 110, 114, 116, 118.

In the illustrated embodiment, the processing system 108 is also coupled to the communications system 112, which is configured to support communications to and/or from the aircraft 102 via a communications network. For example, the communications system 112 may also include a data link system or another suitable radio communication system that supports communications between the aircraft 102 and one or more external monitoring systems, air traffic control, and/or another command center or ground location. In this regard, the communications system 112 may allow the aircraft 102 to receive information that would otherwise be unavailable to the pilot and/or co-pilot using the onboard systems 114, 116, 118, 120.

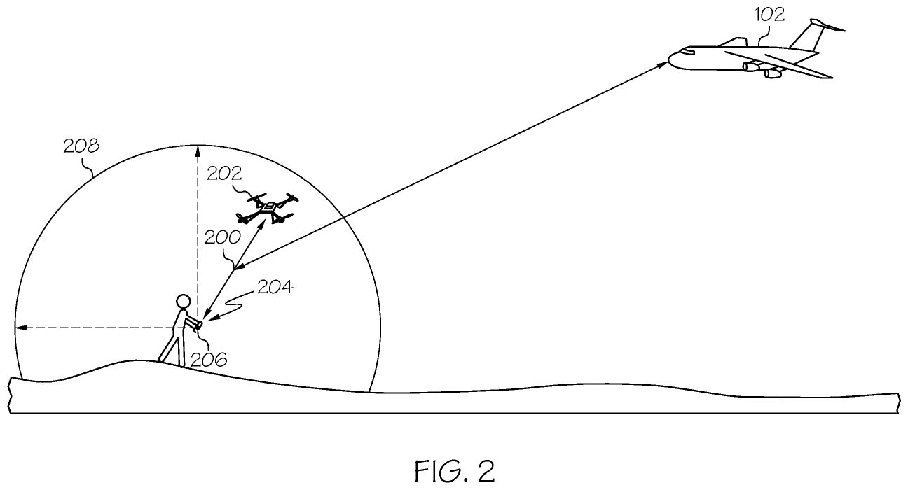

Referring to FIG. 2 and with continued reference to FIG. 1, in exemplary embodiments, the aircraft 102 includes an unmanned aerial vehicle (or drone) detection system 130 that is capable of detecting or otherwise identifying the presence of unmanned aerial vehicles in a vicinity of the aircraft 102. For example, the drone detection system 130 may include one or more radio frequency antennas or radar capable of receiving, detecting, or otherwise identifying radio frequency communications signals 200 between an unmanned aerial vehicle (or drone) 202 and its associated remote controller 204. Based on characteristics or parameters of the detected radio frequency command signals 200 emanating from the remote controller 204, the drone detection system 130 and/or the processing system 108 calculates or otherwise determines a geographic position 206 associated with the remote controller 204, which corresponds to a position of the operator of the drone 202. Based on the operator position 206 and the characteristics or parameters of the detected signals 200, the drone detection system 130 and/or the processing system 108 also calculates or otherwise determines an estimate of the operating range 208 for the drone 202. In this regard, the estimated operating range 208 corresponds to the range of potential geographic location and altitude combinations for which the drone 202 could be located at any given point in time given the current operator position 206. In some embodiments, one or more characteristics or parameters of the detected signals 200 may be utilized by the drone detection system 130 to identify or otherwise determine a particular type of drone 202 that was detected (e.g., make, model, and/or the like) and then determine the estimated operating range 208 based on the type of drone 202 (e.g., by searching a lookup table or similar data storage maintaining specification data for different types of drones or otherwise obtaining specification data for the particular type, make or model of drone 202 (e.g., via a communications network)).

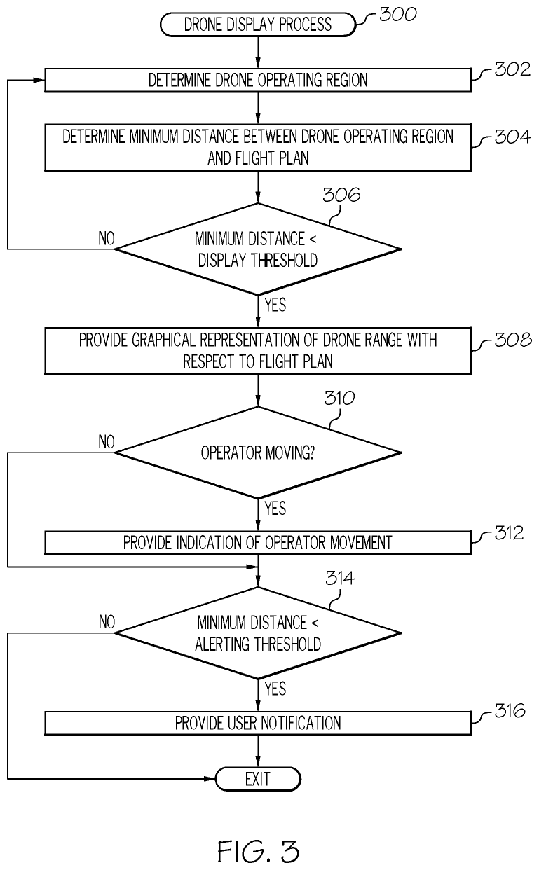

Depending on the embodiment, the drone detection system 130 may utilize multilateration, time difference of arrival, triangulation, trilateration, or any number of other known signal detection and analysis techniques to determine the operator position 206 and range 208 for the drone 202, and the subject matter described herein is not intended to be limited to any particular technique or method of determining the operator position 206 and/or the estimated drone range 208. Additionally, it should be noted that although FIG. 2 depicts a substantially symmetrical and spherical operating range 208 that is substantially centered on the operator position 206, in practice, the estimated operating range 208 may be elliptical or otherwise exhibit any number of different forms based on the directionality of the antennas and/or transmitters associated with the remote controller 204, the transmission range of the antennas and/or transmitters associated with the remote controller 204, and/or the like. In this regard, practical embodiments may involve estimated drone operating ranges that are not symmetrical, not centered about the operator position, or both. As described in greater detail below in the context of FIGS. 3-5, in exemplary embodiments, the processing system 108 calculates or otherwise determines a minimum distance between the estimated operating range 208 and a route defined by the flight plan for the aircraft 102, and when the minimum distance is less than a display threshold, the processing system 108 displays or otherwise presents a graphical representation of the estimated operating range 208 with respect to a graphical representation of the flight plan route on the display device 104, thereby providing a pilot, co-pilot, or other operator of the aircraft 102 situational awareness with respect to the spatial relationship between the drone 202 and the aircraft 102.

It should be understood that FIG. 1 is a simplified representation of the aircraft system 100 for purposes of explanation and ease of description, and FIG. 1 is not intended to limit the application or scope of the subject matter described herein in any way. It should be appreciated that although FIG. 1 shows the display device 104, the user input device 106, and the processing system 108 as being located onboard the aircraft 102 (e.g., in the cockpit), in practice, one or more of the display device 104, the user input device 106, and/or the processing system 108 may be located outside the aircraft 102 (e.g., on the ground as part of an air traffic control center or another command center) and communicatively coupled to the remaining elements of the aircraft system 100 (e.g., via a data link and/or communications system 112). For example, in some embodiments, the drone detection system 130 may be external to the aircraft 102 and realized as a terrestrial or satellite-based system that communicates information pertaining to unmanned vehicles to aircraft 102 via the communications system 112. In some embodiments, the display device 104, the user input device 106, and/or the processing system 108 may be implemented as an electronic flight bag that is separate from the aircraft 102 but capable of being communicatively coupled to the other elements of the aircraft system 100 when onboard the aircraft 102. Similarly, in some embodiments, the data storage element 124 may be located outside the aircraft 102 and communicatively coupled to the processing system 108 via a data link and/or communications system 112. Furthermore, practical embodiments of the aircraft system 100 and/or aircraft 102 will include numerous other devices and components for providing additional functions and features, as will be appreciated in the art. In this regard, it will be appreciated that although FIG. 1 shows a single display device 104, in practice, additional display devices may be present onboard the aircraft 102. Additionally, it should be noted that in other embodiments, features and/or functionality of processing system 108 described herein can be implemented by or otherwise integrated with the features and/or functionality provided by the display system 110 or the FMS 116, or vice versa. In other words, some embodiments may integrate the processing system 108 with the display system 110 or the FMS 116; that is, the processing system 108 may be a component of the display system 110 and/or the FMS 116.

Referring now to FIG. 3, in an exemplary embodiment, the aircraft system 100 is configured to support a drone display process 300 and perform additional tasks, functions, and operations described below. The various tasks performed in connection with the illustrated process 300 may be implemented using hardware, firmware, software executed by processing circuitry, or any combination thereof. For illustrative purposes, the following description may refer to elements mentioned above in connection with FIGS. 1-2. In practice, portions of the drone display process 300 may be performed by different elements of the system 100, such as, the processing system 108, the display system 110, the communications system 112, the navigation system 114, the FMS 116, the onboard avionics systems 118 and/or the drone detection system 130. It should be appreciated that the drone display process 300 may include any number of additional or alternative tasks, the tasks need not be performed in the illustrated order and/or the tasks may be performed concurrently, and/or the drone display process 300 may be incorporated into a more comprehensive procedure or process having additional functionality not described in detail herein. Moreover, one or more of the tasks shown and described in the context of FIG. 3 could be omitted from a practical embodiment of the drone display process 300 as long as the intended overall functionality remains intact.

Referring to FIG. 3 with continued reference to FIGS. 1-2, the drone display process 300 begins by identifying or otherwise determining the potential geographic region that the drone could be operating within (task 302). For example, as described above, in exemplary embodiments, an onboard detection system 130 detects radio frequency communications signals 200 between the drone 202 and its associated remote controller 204, which, in turn, are utilized to calculate or otherwise determine, at the aircraft 102, a geographic position 206 associated with the remote controller 204 and an estimated operating range 208 for the drone 202, as described above. The relationship of the estimated drone operating range 208 about the geographic position 206 of the operator 204 may be mapped to a corresponding geographic operating region for the drone 202, which corresponds to the range of potential coordinate locations (e.g., latitude and longitude coordinates) and altitude combinations where the drone 202 could be located at any point in time given the operator position 206. Thereafter, the drone display process 300 calculates or otherwise determines a minimum distance between the drone operating region and the route defined by the flight plan and determines whether the minimum distance is less than a display threshold (tasks 304, 306). In this regard, the processing system 108 may calculate or otherwise determine the real-world geographic distance between a point along the periphery of the drone operating region that is closest to the route defined by the flight plan and identify when the shortest distance between the drone operating region and the flight plan route is less than the display threshold distance. In other embodiments, the processing system 108 may calculate or otherwise determine a monitoring corridor having a width on either side of the route defined by the flight plan corresponding to the display threshold distance, and thereafter detect or otherwise identify when the monitoring corridor overlaps at least a portion of the drone operating region.

When the drone operating region is within the display threshold distance of the flight plan route, the drone display process 300 displays, presents, or otherwise provides a graphical representation of the estimated operating range for the drone with respect to the route defined by the flight plan (task 308). For example, as described in greater detail below, in one or more exemplary embodiments, the processing system 108 updates a navigational map displayed on the display device 104 to include a two-dimensional representation of the estimated operating range 208 for the drone 202 that overlaps the corresponding geographic region about the geographic position 206 of the drone operator. In this regard, the navigational map may concurrently depict a graphical representation of the route defined by the flight plan along with a graphical representation of the estimated operating range for the drone at its appropriate geographic location. Additionally, or alternatively, the processing system 108 may also update a vertical profile of the flight plan displayed on the display device 104 to include a graphical representation of the estimated operating range 208 with respect to the vertical profile of the route of the flight plan. In this regard, on the vertical profile display, the vertical dimension of the graphical representation of the estimated operating range 208 corresponds to the range of potential altitudes for the drone 202 relative to the drone operator position 206 while the horizontal dimension of the depicted operating range 208 corresponds to the lateral dimension of the drone operating region 208 that is aligned parallel to the flight plan route.

Still referring to FIG. 3, in exemplary embodiments, the drone display process 300 calculates or otherwise determines whether the operator of the drone is moving, and if so, generates or otherwise provides indication of the direction of motion for the operator of the drone (tasks 310, 312). In this regard, the processing system 108 may store or otherwise maintain one or more previously determined operator positions 206 and, for each iteration, compare the currently determined operator position 206 with one or more preceding positions to detect or otherwise identify a change in operator positions (e.g., a difference between successive positions) that exceeds a threshold change in position that indicates that the drone operator is moving. When the drone operator is moving, the processing system 108 calculates or otherwise determines a heading associated with the drone operator's movement based on the successive operator positions (e.g., based on the difference in the most recent drone operator position relative to one or more preceding position(s)). In exemplary embodiments, the processing system 108 generates or otherwise provides a corresponding indication of the direction of the drone operator movement on the display device 104 in conjunction with the graphical representation of the drone operating range. For example, in one or more embodiments, the processing system 108 generates or otherwise provides an arrow, arrowhead, or similar feature that emanates from the graphical representation of the drone operating range in a direction that corresponds to the direction of the drone operator movement. In this regard, in some embodiments, the length or other dimension or characteristic of the operator movement indicator may correspond to the rate of movement, thereby providing indication of both the direction in which the drone operator appears to be moving as well as the rate at which the drone operator is moving in that direction. It should be noted that the subject matter described herein is not intended to be limited to arrows or any other particular feature utilizes to indicate drone operator movement, and in practice, any number of different graphical features, animations, or the like could be employed to convey the nature of the drone operator's position to a pilot.

In exemplary embodiments, the drone display process 300 also calculates or otherwise determines whether the distance between the drone operating region and the flight plan route is less than an alerting threshold, and if so, generates or otherwise provides a notification that is indicative of the heightened risk posed by the drone (tasks 314, 316). For example, in various embodiments, the processing system 108 may automatically graphically emphasize the drone operating range depicted on the display device 104 by changing the color the drone operating range is rendered in to indicate a higher level of risk (e.g., from amber to magenta); however, it should be noted that the subject matter is not limited to any particular manner of graphically emphasizing the drone operating range, and in practice, any type or combination of visually distinguishable characteristics may be utilized to emphasize the drone operating range, including different colors, different hues, different tints, different levels of transparency, translucency, opacity, contrast, brightness, or the like, different shading, texturing, fill patterns, and/or other graphical effects. In some embodiments, the processing system 108 may automatically generate or provide a user notification on the display device 104, via an audio output device, or the like that indicates a potential drone within the alerting threshold distance of the flight plan route. A pilot may then ascertain the relative potential significance or impact of the drone and modify or alter the flight plan route (or the operation of the aircraft with respect to the flight plan route) to mitigate the potential risk posed by the drone. In one or more embodiments, a FMS 114 or other onboard avionics system may automatically suggest or recommend one or more waypoints to modify the route to avoid the detected drone. For example, based on the potential operating range, the FMS 114 may select or otherwise identify one or more alternative waypoints that decrease the likelihood of the detected drone interfering with the flight while also minimizing the amount of time required, fuel required, or some other cost index for reaching the destination or otherwise reengaging with the original flight plan route.

In exemplary embodiments, the drone display process 300 is continually repeated during flight to dynamically update the displays onboard the aircraft 102 to reflect the changing threats posed by drones or other unmanned vehicles during flight. In this regard, as drones or other remotely-controlled unmanned vehicles begin to encroach on the route defined by the aircraft's flight plan, the navigational map display and/or the vertical profile display on the display device 104 may be updated to provide indication to a pilot or co-pilot of potential encroachment with respect to an upcoming portion of the flight plan route. Based on the relative distance between the depicted drone range and the planned route, the pilot or co-pilot may determine whether to alter the route, alter the flight level, or otherwise initiate some other remedial action (e.g., activate a jammer) to mitigate the potential threat. Conversely, as drones or other remotely-controlled unmanned vehicles move away from planned route, they may automatically be removed from the display once the separation distance exceeds the display threshold distance, thereby dynamically decluttering the display.

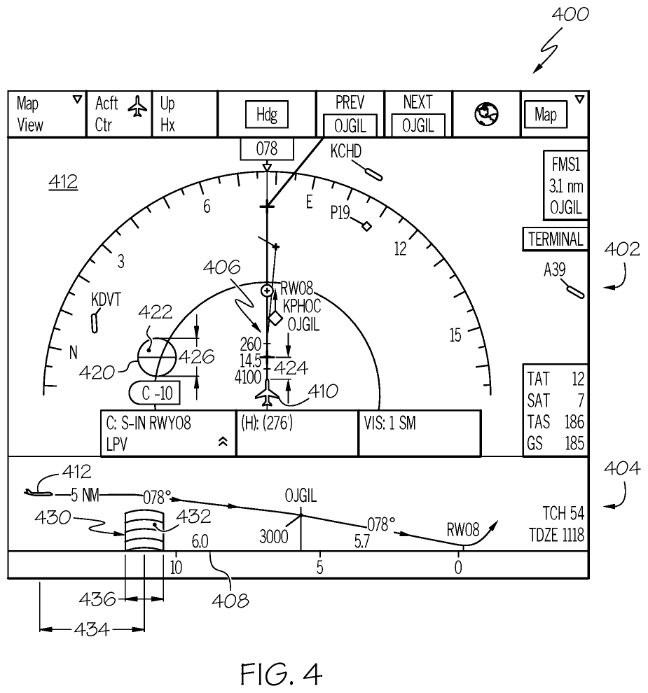

FIG. 4 depicts an exemplary graphical user interface (GUI) display 400 that may be displayed, rendered, or otherwise presented by the processing system 108 and/or display system 110 on a display device 104 onboard an aircraft 102 in conjunction with the drone display process 300 of FIG. 3. The graphical user interface display includes a navigational map display 402 and a vertical profile display 404 adjacent to the navigational map display 402. The navigational map 402 includes a graphical representation of a portion of route 406 defined by a flight plan for the aircraft 102, while the vertical profile display 404 includes a graphical representation 408 of the vertical profile of the portion of the flight plan route depicted on the navigational map 402 that is ahead of the aircraft 102 or is otherwise yet to be flown by the aircraft 102. In this regard, the illustrated vertical profile display 404 includes a graphical representation 412 of the aircraft 102 that is disposed at or near a left edge of the vertical profile display 404 at a vertical position that corresponds to the current altitude of the aircraft 102, with the vertical profile of the route 408 extending from the left edge of the vertical profile display 404 towards the right of the vertical profile display 404 with vertical positions at the respective horizontal positions along the route 408 corresponding to the planned altitude for the aircraft 102 at the navigational reference points or geographic locations corresponding to the respective horizontal positions on the vertical profile display 404 with respect to the current aircraft position.

The illustrated navigational map 402 includes a graphical representation 410 of the aircraft 102 overlaid or rendered on top of a background 412. The background 412 comprises a graphical representation of the terrain, topology, navigational reference points, airspace designations and/or restrictions, or other suitable items or points of interest corresponding to the currently displayed area of the navigational map 402, which may be maintained in a terrain database, a navigational database, a geopolitical database, or another suitable database. For example, the display system 110 may render a graphical representation of navigational aids (e.g., VORs, VORTACs, DMEs, and the like) and airports within the currently displayed geographic area of the navigational map 402 overlying the background 412. Some embodiments of navigational map 402 may also include graphical representations of airspace designations and/or airspace restrictions, cities, towns, roads, railroads, and other geo-political information. Although FIG. 4 depicts a top view (e.g., from above the aircraft 410) of the navigational map 402 (alternatively referred to as a lateral map or lateral view), in practice, alternative embodiments may utilize various perspective views, such as side views, three-dimensional views (e.g., a three-dimensional synthetic vision display), angular or skewed views, and the like. The displayed area of the navigational map 402 corresponds to the geographic area that is currently displayed in the navigational map 402, that is, the field of view about the center location of the navigational map 402. As used herein, the center location of the navigational map 402 comprises a reference location for the middle or geometric center of the navigational map 402 which corresponds to a geographic location.

In an exemplary embodiment, the navigational map 402 is associated with the movement of the aircraft 102, and the aircraft symbology 410 and/or background 412 refreshes or otherwise updates as the aircraft 102 travels, such that the graphical representation of the aircraft 410 is positioned over the terrain background 412 in a manner that accurately reflects the current (e.g., instantaneous or substantially real-time) real-world positioning of the aircraft 102 relative to the earth. In some embodiments, the aircraft symbology 410 is shown as traveling across the navigational map 402 (e.g., by updating the location of the aircraft symbology 410 with respect to the background 412), while in other embodiments, the aircraft symbology 410 may be located at a fixed position on the navigational map 402 (e.g., by updating the background 412 with respect to the aircraft graphic 410 such that the map 402 is maintained centered on and/or aligned with the aircraft graphic 410). Additionally, depending on the embodiment, the navigational map 402 may be oriented in a cardinal direction (e.g., oriented north-up so that moving upward on the map 402 corresponds to traveling northward), or alternatively, the orientation of the navigational map 402 may be track-up or heading-up (i.e., aligned such that the aircraft symbology 410 is always traveling in an upward direction and the background 412 adjusted accordingly). In this regard, the illustrated map 402 depicts an embodiment where the aircraft symbology 410 has a fixed position on the navigational map 402 in a track-up or heading-up, where the background 412 and other symbology on the navigational map 402 continually updates with respect to the aircraft symbology 410 as the aircraft 102 travels.

Referring to FIG. 4 with reference to FIGS. 1-3, in the illustrated embodiment, a graphical representation 420 of the operating range 208 for a drone 202 detected within a display threshold distance of the route 406 is depicted overlying the terrain background 412 at the geographic location corresponding to the potential geographic operating region for the drone based on the determined operator position 206. In this regard, the depicted drone operating region 420 encompasses the range of potential geographic coordinate locations for the drone 202 based on the detected operator position 206 and estimated operating range 208. Additionally, a graphical representation 422 of the drone operator is depicted within the drone operating region 420 overlying the terrain background 412 at a location corresponding to the geographic position 206 of the remote controller 204 associated with the drone 202. In exemplary embodiments, when the minimum distance between the operating range 208 and the flight plan route 406 is less than the display threshold distance but greater than an alerting threshold distance, the drone operating region 420 and the operator position 422 are rendered using one or more visually distinguishable characteristics corresponding to a relatively lower priority or relatively low threat level (e.g., an amber color, a relatively higher transparency, and/or the like). Conversely, if the minimum distance between the operating range 208 and the flight plan route 406 falls below the alerting threshold distance (e.g., as the operator moves in a direction towards the route 406), the drone operating region 420 and the operator position 422 are rendered using one or more different visually distinguishable characteristics to notify the pilot, co-pilot, or other user of a relatively higher priority or threat level for the detected drone (e.g., a magenta color, an increased line thickness, a relatively lower transparency, highlighting, flashing, and/or the like).

Similarly, the vertical profile display 404 includes graphical representation 430 of the operating range 208 for a drone 202 with respect to the vertical profile of the route 408. In this regard, the graphical representation 430 corresponds to a vertical column of altitudes at which the drone 202 could be flying at based on the estimated drone range 208 and the altitude associated with the operator position 206. The vertical drone operating range 430 is depicted at a horizontal position with respect to the graphical representation of the aircraft 412 on the vertical profile display 404 such that the horizontal distance 434 between the center of the vertical drone operating range 430 and the aircraft 412 corresponds to the lateral distance 424 between center of the drone operating region 420 and the current aircraft location that is parallel to the route 406 or otherwise measured along the route 406 (e.g., the along-track distance). Similarly, the horizontal width 436 of the vertical drone operating range 430 corresponds to the lateral distance 426 between extents of the drone operating region 420 measured along a line or axis parallel to the route 408. Additionally, a graphical representation 432 of the operator position may be depicted at a horizontal position with respect to the graphical representation of the aircraft 412 on the vertical profile display 404 that corresponds to the along-track distance between the aircraft 102 and the operator position 206.

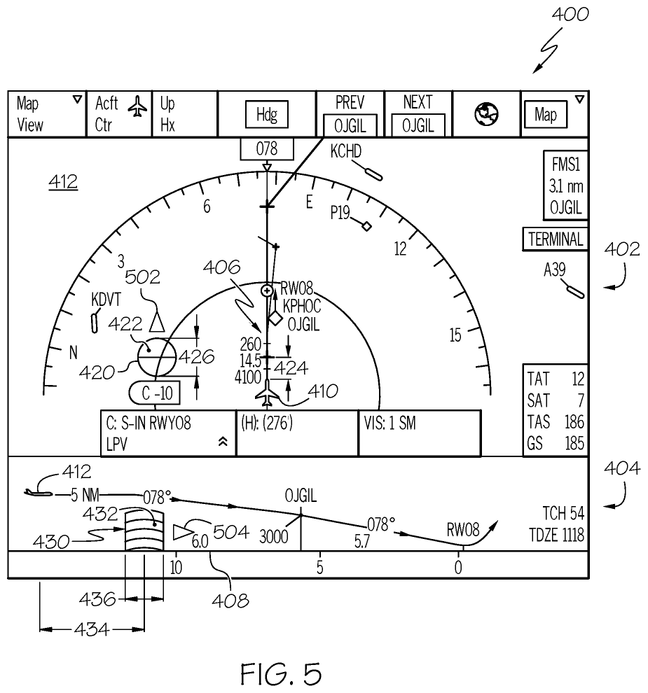

Referring to FIG. 5 with continued reference to FIGS. 1-4, in exemplary embodiments, the GUI display 400 may be dynamically updated as the aircraft 102 travels to reflect changes in the position or status of the drone with respect to the flight plan. In this regard, FIG. 5 depicts an exemplary update to the GUI display 400 in response to detecting movement of the remote controller 204 or change to the detected operator position 206, as described above in the context of FIG. 3. In response to a change in successive operator positions that is greater than a movement detection threshold, the processing system 108 generates or otherwise provides graphical indicia 502, 504 of the direction of movement to the operator position 206 on the GUI display 400. In this regard, FIG. 5 depicts an example where the detected movement is substantially parallel to the route 406, 408 in the same direction or heading as the aircraft 102. In the embodiment of FIG. 5, the graphical indicia 502, 504 is realized as an arrowhead emanating from the depicted drone operating ranges 420, 430; however, it should be noted the subject matter described herein is not limited to any particular type of graphical indicia for operator movement. Additionally, as described above, in some embodiments, the size or length of the graphical indicia 502, 504 may correspond to the rate of movement of the operator position 206 (or the relative difference between successive operator positions) to further convey the nature of the change in the potential drone operating region 420, 430 to the pilot, co-pilot, or other aircraft operator.

As described above, as the drone operating range 420 laterally encroaches on the flight plan route 406 to within an alerting threshold distance, the depicted operating ranges 420, 430 may be dynamically updated and rendered using one or more different visually distinguishable characteristics to visually indicate an increase in the potential risk associated with the detected drone 202. Conversely, as the drone operating range 420 moves laterally beyond the minimum display threshold distance from the flight plan route 406, the GUI display 400 may be dynamically updated to remove the depicted operating ranges 420, 430 and thereby declutter the GUI display 400.

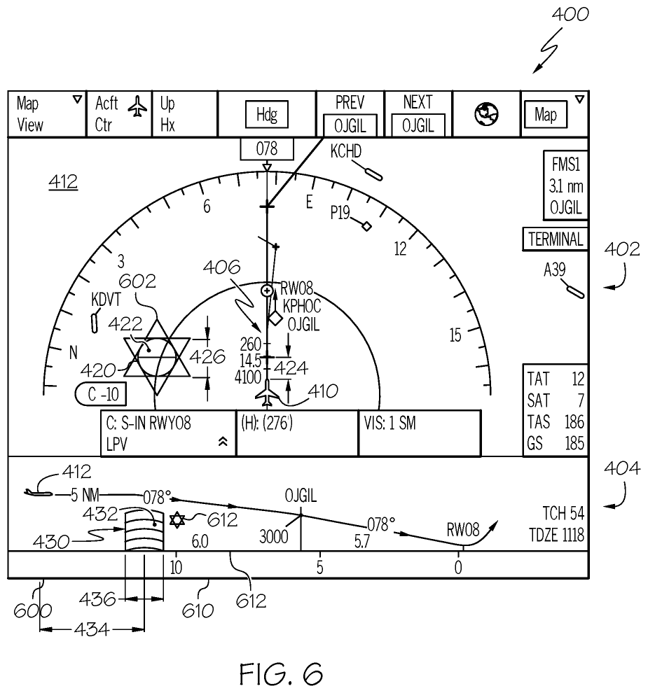

Referring to FIG. 6 with continued reference to FIGS. 1-5, in one or more exemplary embodiments, the GUI display 400 may be dynamically updated to provide graphical indicia or notifications when it is determined that the detected drone is returning to a home position (or homing) or that the previously detected signals 200 have been lost or are no longer detected. For example, an additional graphical indicia 600, 610 may be provided with respect to the depicted drone operating ranges 420, 430 to indicate that the signal has been lost or that the drone is otherwise believed to be returning to a homing position. In this regard, graphical representation of the homing position 602, 612 may be provided on the GUI display 400. Depending on the embodiment, the homing position 602, 612 could be realized as the most recently detected operator position or some other predefined or predetermined point associated with the detected drone.

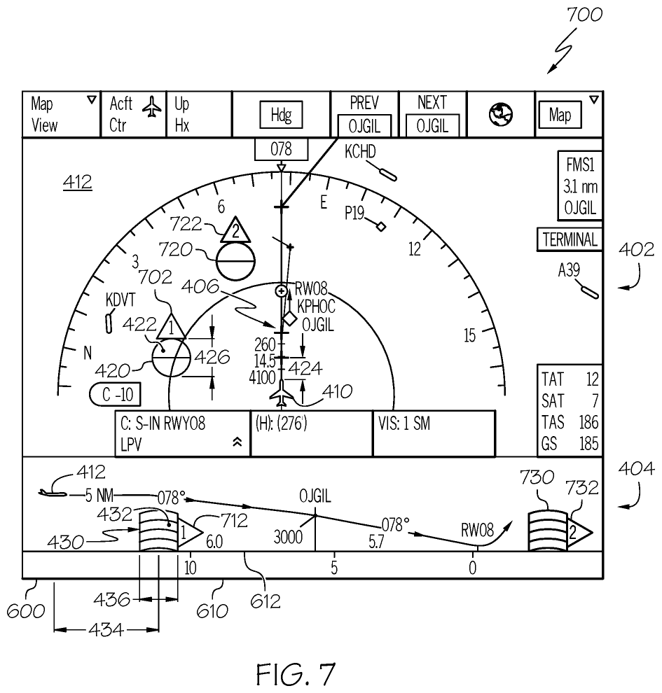

FIG. 7 depicts an exemplary GUI display 700 depicting an exemplary scenario where multiple drones are detected within a threshold distance of the flight plan route 406. Similar to drone operating ranges 420, 430, estimated drone operating ranges 720, 730 associated with a second drone may be determined and depicted on the GUI display 700 concurrently to depiction of drone operating ranges 420, 430. Additionally, graphical indicia 702, 712, 722, 732 may be provided that enable the pilot or other user to correlate and differentiate the operating ranges 420, 430, 720, 730 across the different displays 402, 404. For example, the graphical indicia 702, 712 of operator movement associated with the first drone operating ranges 420, 430 may include a number or other identifier that enables correlating the ranges 420, 430 between displays 402, 404, while the graphical indicia 722, 732 of operator movement associated with the second drone operating ranges 720, 730 may include different number or identifier that enables correlating the ranges 720, 730 between displays 402, 404 while differentiating the second drone vertical operating range 730 from the first drone lateral operating range 420 and vice versa based on the identifier or numbering.

By virtue of the subject matter described herein, the pilot or other vehicle operator is apprised of the potential threat of unmanned vehicles or other vehicles operating in the vicinity of a planned route of travel that could otherwise be invisible, unnoticeable, or undetectable. In the aviation context, by graphically depicting the range of potential positions and altitudes for a drone, the pilot can ascertain the relative degree of risk posed by operations of the drone near the planned route of travel and adjust or modify the flight plan or flight level accordingly to mitigate the potential threat.

For the sake of brevity, conventional techniques related to flight planning, drone detection, graphics and image processing, avionics systems, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method comprising:
displaying a graphical representation of a route for a vehicle on a display device onboard the vehicle;
determining a range of an unmanned vehicle based on one or more signals associated with the unmanned vehicle; and
when at least some of the range is within a threshold distance of the route, displaying a graphical representation of the range of the unmanned vehicle on the display device.

2. The method of claim 1, wherein:
displaying the graphical representation comprises displaying a graphical representation of a flight plan for an aircraft on a navigational map on the display device onboard the aircraft; and
displaying the graphical representation of the range of the unmanned vehicle comprises displaying the graphical representation of the range of the unmanned vehicle on the navigational map.

3. The method of claim 2, further comprising:
determining a direction of motion of an operator associated with the unmanned vehicle based on the one or more signals; and
displaying graphical indication of the direction of motion on the navigational map in association with the graphical representation of the range of the unmanned vehicle.

4. The method of claim 2, further comprising:
displaying a graphical representation of the flight plan for the aircraft on a vertical profile display on the display device onboard the aircraft; and
displaying a second graphical representation of the range of the unmanned vehicle on the vertical profile display.

5. The method of claim 1, wherein:
displaying the graphical representation comprises displaying a graphical representation of a flight plan for an aircraft on a vertical profile display on the display device onboard the aircraft; and
displaying the graphical representation of the range of the unmanned vehicle comprises displaying the graphical representation of the range of the unmanned vehicle on the vertical profile display.

6. The method of claim 5, further comprising:
determining a direction of motion of an operator associated with the unmanned vehicle based on the one or more signals; and
displaying graphical indication of the direction of motion on the vertical profile display in association with the graphical representation of the range of the unmanned vehicle.

7. The method of claim 1, further comprising detecting, by a detection system onboard the vehicle, the one or more signals being communicated between a remote controller and the unmanned vehicle prior to determining the range of the unmanned vehicle at the vehicle based on the detected one or more signals.

8. The method of claim 7, further comprising determining, at the vehicle, an operator position associated with the remote controller based on the one or more signals, wherein determining the range comprises determining the range relative to the operator position.

9. The method of claim 8, wherein determining the range comprises determining a set of potential geographic location and altitude combinations where the unmanned vehicle could be located based at least in part on the operator position.

10. The method of claim 1, further comprising receiving, via a communications system onboard the vehicle, the range of the unmanned vehicle from an external system, wherein the external system detects the one or more signals being communicated between a remote controller and the unmanned vehicle and determines the range based at least in part on the detected one or more signals.

11. A method of presenting a drone on a display device onboard an aircraft, the method comprising:
displaying, on a display device onboard the aircraft, a graphical representation of a route defined by a flight plan for the aircraft;
detecting, by a detection system onboard the aircraft, one or more radio frequency communications signals between a remote controller and the drone;
determining a potential operating region for the drone based on the one or more radio frequency communications signals; and
in response to determining the potential operating region is within a display threshold distance of the route, displaying a graphical representation of the potential operating region for the drone on the display device.

12. The method of claim 11, further comprising displaying, on the display device, a navigational map associated with the aircraft, wherein the navigational map includes the graphical representation of the potential operating region for the drone and the graphical representation of the route defined by the flight plan.

13. The method of claim 12, further comprising obtaining a current location of the aircraft from an onboard system, wherein the navigational map comprises a graphical representation of the aircraft at a location corresponding to the current location.

14. The method of claim 12, further comprising:
determining a direction of motion associated with the remote controller based on the one or more radio frequency communications signals; and
displaying graphical indication of the direction of motion on the navigational map in association with the graphical representation of the potential operating region for the drone.

15. The method of claim 11, further comprising displaying, on the display device, a vertical profile display, wherein:
the graphical representation of the route comprises a graphical representation of an altitude profile of the route on the vertical profile display; and
the graphical representation of the potential operating region for the drone comprises a graphical representation of a potential range of altitudes for the drone on the vertical profile display.

16. The method of claim 15, further comprising:
obtaining a current location of the aircraft from an onboard system; and
determining an along track distance between the current location of the aircraft and the potential operating region for the drone, wherein:
the vertical profile display comprises a graphical representation of the aircraft vertically positioned at a location corresponding to a current altitude of the aircraft; and
the graphical representation of the potential range of altitudes is horizontally positioned at a location with respect to the graphical representation of the aircraft that corresponds to the along track distance.

17. The method of claim 15, wherein a horizontal dimension of the graphical representation of the potential range of altitudes for the drone corresponds to a lateral distance of the potential operating region parallel to the route defined by the flight plan.

18. The method of claim 15, further comprising:
determining a direction of motion associated with the remote controller based on the one or more radio frequency communications signals; and
displaying graphical indication of the direction of motion on the vertical profile display in association with the graphical representation of the potential range of altitudes for the drone.

19. An aircraft system comprising:
a display device to display a graphical representation of a flight plan;
a detection system to detect one or more radio frequency communications signals associated with an unmanned aerial vehicle; and
a processing system coupled to the display device and the detection system to determine an operating range associated with the unmanned aerial vehicle based on the one or more radio frequency communications signals and display a graphical representation of the operating range on the display device when at least a portion of the operating range is within a threshold distance of the flight plan.

20. The aircraft system of claim 19, wherein the processing system is configured to determine a direction of motion of a remote controller associated with the unmanned aerial vehicle and provide graphical indication of the direction of motion on the display device in conjunction with the graphical representation of the operating range.
